(19) United States
(12) Patent Application Publication
(10) Pub. No.: US 2025/0296482 A1
(43) Pub. Date: Sep. 25, 2025

(54) AN APPARATUS FOR MEASURING LOAD CHARACTERISTICS

(71) Applicants: Saad Jabir, Duisburg (DE); Nuralhuda Jabir, Duisburg (DE); Giuseppe Celle, Rozzano (IT)

(72) Inventors: Saad Jabir, Duisburg (DE); Nuralhuda Jabir, Duisburg (DE); Giuseppe Celle, Rozzano (IT)

(73) Assignees: Saad Jabir, Duisburg (DE); Nuralhuda Jabir, Duisburg (DE); Giuseppe Celle, Rozzano (IT)

(21) Appl. No.: 19/083,080

(22) Filed: Mar. 18, 2025

Related U.S. Application Data
(60) Provisional application No. 63/568,050, filed on Mar. 21, 2024.

(51) Int. Cl. B60N 2/00; G01L 5/1627; G01L 5/165; G01L 5/166

(52) U.S. Cl. CPC B60N 2/0025; B60N 2/003; G01L 5/1627; G01L 5/165; G01L 5/166; B60N 2210/42; B60N 2210/48; B60N 2230/30

(57) ABSTRACT

Embodiments of the present invention provide an apparatus comprising an upper plate and a lower plate. A plurality of horizontal load cells and a plurality of vertical load cells positioned on the lower plate to measure the forces in an x-direction, a y-direction, and a z-direction. A plurality of holes provided on the upper plate. A plurality of pins are fixed on the horizontal load cells and inserted into each correspondence hole. A plurality of spherical balls placed between the horizontal load cells and the upper plate. The spherical balls are provided to determine the force in the z-direction and the movement of the upper plate in the x-direction and the z-direction. A plurality of first sensor and a plurality of second sensors are provided over the upper plate and around the upper plate over the wall, respectively.

### TECHNICAL FIELD

The present invention relates to force measurement and analysis devices, particularly to an apparatus designed for accurately measuring and analyzing three-dimensional forces in applications such as orthopedics, sports, rehabilitation, gait analysis, automobiles and other fields. The apparatus in the present invention enhances the understanding of force distribution and load dynamics, offering invaluable insights into biomechanics and movement patterns.

### BACKGROUND ART

In biomechanics, the measurement of forces exerted by the human body or mechanical structures plays a pivotal role in understanding movement dynamics, assessing performance, and facilitating rehabilitation. Further, the gait analysis requires precise measurement of forces acting on the lower limbs during walking or running. Similarly, rehabilitation programs benefit from quantifying forces to evaluate progress and tailor interventions. In sports science, understanding the biomechanics of athletic movements necessitates advanced force measurement techniques. In orthopedics, accurate measurement and analysis of forces are crucial for diagnosing musculoskeletal conditions, planning surgical interventions, and assessing treatment outcomes. During various activities, the forces exerted on joints, bones, and soft tissues provide valuable insights into biomechanical abnormalities, joint instability, and tissue stress distribution.

In conventional devices, measuring forces in the z-direction is feasible, while measuring forces in the x and y-directions poses challenges. Due to design limitations, some traditional devices can accurately measure the forces in the z-direction but fail to measure the forces in the x and y directions accurately. This limitation in design often leads to errors in force measurement. Additionally, conventional devices such as those used for Center of Pressure (COP) analysis, gait analysis, balance assessment, rehabilitation, and sports biomechanics each have specific capabilities and limitations, preventing comprehensive analysis from being performed by a single device. These limitations hinder the accurate assessment of various parameters, limiting the effectiveness of these devices in providing comprehensive insights into human movement and biomechanics.

Therefore, there is a need in the art for developing an apparatus that does not suffer from the aforementioned deficiencies.

### OBJECTS OF THE INVENTION

Some of the objects of the invention are as follows:

An object of the present invention is to develop an apparatus that is capable of determining forces in an x-direction, a y-direction, and a z-direction.

Another object of the present invention is to develop an apparatus that is capable of determining the position of the resultant forces exerted by a load.

Another object of the present invention is to develop an apparatus that is capable of determining the COP (center of pressure) of a body of the load and load distribution.

Another object of the present invention is to develop an apparatus that is capable of determining the balance of the load.

Another object of the present invention is to develop an apparatus that is capable of conducting Gait analysis.

Another object of the present invention is to develop an apparatus that is capable of designing and evaluating rehabilitation programs.

Another object of the present invention is to develop an apparatus suitable for facilitating orthopedics and sports science research.

Another object of the present invention is to develop an apparatus that is capable of determining the shape of the load.

Another object of the present invention is to provide an apparatus for measuring load and COP on a seat of a vehicle.

Another object of the present invention is to provide an apparatus for measurement and analysis of dynamic weight characteristics of a passenger seating on a seat of a vehicle in the x, y, and z directions during the vehicle travel.

Another object of the present invention is to connect different apparatus to measure the three-dimensional forces and vibration of different mechanical structures, e.g., treadmills or tires.

Another object of the present invention is to develop an apparatus capable of analyzing losses during walking and running attributable to plane forces that are not in the direction of walking or running, by positioning multiple apparatus under a treadmill.

Yet another object of the present invention is to develop a cost-effective apparatus.

### SUMMARY OF THE INVENTION

According to first aspect of the present invention, an apparatus for measurement and analysis of load is provided. The apparatus comprising: an upper plate and a lower plate; a plurality of horizontal load cells and a plurality of vertical load cells positioned on the lower plate to measure the forces in an x-axis, a y-axis and a z-axis; a plurality of holes provided on the upper plate; and wherein a plurality of pins are provided to connect with each of said horizontal load cells, with each of the plurality of pins is in contact with each of the plurality of holes provided on the upper plate.

In one embodiment of the invention, the apparatus further comprising a wall that extends from the periphery of the lower plate towards the upper plate up to a first distance, with the upper plate maintaining a predetermined distance from the wall.

In one embodiment of the invention, the apparatus further comprising a plurality of second sensors installed on the upper plate to determine a first parameter.

In one embodiment of the invention, the apparatus further comprising a plurality of second sensors installed on the wall located around the upper plate to determine a second parameter.

In one embodiment of the invention, the first parameter and the second parameter includes but are not limited to a shape of load, a center of load, a magnitude, and a direction of load.

In one embodiment of the invention, the plurality of first sensors and the plurality of second sensors is selected from a group consisting of a strain gauge, a piezoelectric sensor, a capacitive sensor, a tactile sensor or a combination thereof.

In one embodiment of the invention, the apparatus further comprising a control module integrated into the apparatus to control the plurality of first sensors, the plurality of second sensors, the plurality of horizontal load cells and the plurality of vertical load cells.

In one embodiment of the invention, a plurality of spherical balls are placed between each of the plurality of vertical load cells and the upper plate.

In one embodiment of the invention, the plurality of spherical balls allow displacement of the upper plate in the x-axis and the y-axis.

In one embodiment of the invention, the plurality of holes are elliptical in shape to allow the movement of the plurality of pins in x-axis and the y-axis.

According to the second aspect of the present invention, an apparatus for measuring load information on a seat of a car is provided. The apparatus comprising: a lower plate having a pair of side walls extended vertically upward; an upper plate having a pair of side walls extended vertically downward; wherein the pair of side walls of the upper plate covers the pair of side walls of the lower plate; a plurality of horizontal load cells and a plurality of vertical load cells positioned on the lower plate to measure the forces in an x-axis, a y-axis, and a z-axis.

In one embodiment of the invention, a space is provided between the upper plate and the lower plate.

In one embodiment of the invention, the apparatus further comprising a plurality of first sensor installed on the upper plate to determine a first parameter and a plurality of second sensors on the side wall of the lower plate to determine a second parameter.

In one embodiment of the invention, the apparatus further comprising a control module integrated into the apparatus to control the plurality of first sensors, the plurality of second sensors, the plurality of horizontal load cells, and the plurality of vertical load cells.

In one embodiment of the invention, the control module is linked to a centralized car control system to transmit load information.

In one embodiment of the invention, the lower plate is fixed with a seat screw to allow the upper plate free to apply pressure on the plurality of horizontal load sensors and the plurality of vertical load sensors.

In one embodiment of the invention, the pair of side walls of the lower plate extends vertically upward to form a U-shaped enclosure, and the pair of side walls of the upper plate extends vertically downward to form a U-shaped enclosure.

In one embodiment of the invention, two opposite pair of side walls of the lower plate extends vertically upward to form an open box-shaped enclosure, and the pair of side walls of the upper plate extends vertically downward to form an open box-shaped enclosure.

According to a third aspect of the present invention, an apparatus for measurement and analysis of load is provided. The apparatus comprising: an upper plate and a lower plate; a plurality of horizontal load cells and a plurality of vertical load cells positioned on the lower plate to measure the forces in an x-direction, a y-direction, and a z-direction; a plurality of holes provided on the upper plater; and a plurality of spherical balls placed between each of the vertical load cells and the upper plate; wherein a plurality of first sensors is installed on the upper plate to determine a first parameter, and wherein a plurality of pins is fixed on each of the plurality of horizontal load cells, with each of the plurality of pins inserted into each of the corresponding holes provided on the upper plate.

In one embodiment of the invention, the apparatus further comprising a wall that extends towards the upper plate from the periphery of the lower plate up to a first distance, wherein the upper plate maintains a predetermined distance from the wall and a plurality of second sensors installed on the wall located around the upper plate.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1A illustrates a top view of an apparatus, in accordance with an embodiment of the present invention.

FIG. 1B illustrates a cross-sectional view of the apparatus along a section 1A-1A shown in FIG. 1A.

FIG. 1C illustrates a cross-sectional view of the apparatus along a section 1B-1B shown in FIG. 1A.

FIG. 2 illustrates a top view of the apparatus depicting a plurality of first sensors, in accordance with an embodiment of the present invention.

FIG. 3A illustrates an alternative top view of the apparatus depicting a plurality of pins fixed with an upper plate of the apparatus, in accordance with another embodiment of the present invention.

FIG. 3B illustrates a cross-sectional view of the apparatus along a section 3A-3A shown in FIG. 3A.

FIG. 3C illustrates a cross-sectional view of the apparatus along a section 3B-3B shown in FIG. 3A.

FIG. 4 illustrates a top view of the apparatus depicting schematic of a control module of the apparatus, in accordance with an embodiment of the present invention.

FIG. 5 is a block diagram showing communication between the control module of the apparatus and the external communication device, in accordance with an embodiment of the present invention.

FIG. 6 illustrates the apparatus in a state being used to determine and analyze the forces in static load conditions, in accordance with an embodiment of the present invention.

FIG. 7 illustrates the apparatus in a state being used to determine and analyze the forces in dynamic load conditions, in accordance with an embodiment of the present invention.

FIG. 8 illustrates an application of a plurality of apparatus in a treadmill, in accordance with an embodiment of the present invention.

FIG. 9 shows the apparatus fitted into the seat of a car for measuring load and weight characteristics of the passenger in accordance with an embodiment of the present invention.

FIG. 10 shows a vertical cross-section of the apparatus in accordance with an embodiment of the present invention.

FIG. 11A shows the apparatus with vertical load cells to monitor the movement of the upper plate in z-axis in accordance with an embodiment of the present invention.

FIG. 11B shows the apparatus with horizontal load cells to monitor the movement of the upper plate in x-axis and y-axis in accordance with an embodiment of the present invention.

FIG. 11C shows a configuration of a track to be fitted under a seat of a vehicle to measure horizontal and vertical load in accordance with an embodiment of the present invention.

FIG. 11D shows the top view of the apparatus with the film based sensor in accordance with an embodiment of the present invention.

FIG. 11E shows the side view of the apparatus with the film based sensor to measure the movement in x-axis, y-axis and z-axis in accordance with an embodiment of the present invention.

FIG. 12A shows a top view and FIG. 12B shows a side view of the film based sensor.

FIG. 12C shows the change in resistance value when the upper plate is moved in left and right direction and FIG. 12D shows the change in resistance value when the upper plate is moved in front and back direction.

FIG. 13 shows a treadmill with the apparatus to monitor load characteristics of a person, fitted on a deck of the treadmill, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is, therefore, not to be taken in a limiting sense, and the scope of the present invention disclosure is defined by the appended claims. Embodiments of the claims may, however, be embodied in many different forms and should not be construed as limited to the embodiments set forth herein.

In the context of the specification, “load” refers to the external force or weight applied by an object or structure on a apparatus, which can vary in geometry and distribution. Assessing load involves evaluating how external forces affect the stability, integrity, and performance of the object under different conditions. The load can take on various shapes, such as point loads, distributed loads, or even dynamic loads, each exerting unique stresses on the apparatus.

In the context of the specification, the term “force measurement” refers to the process of quantifying the magnitude and direction of forces exerted on the apparatus.

In the context of the specification, “center of pressure analysis” refers to the examination and determination of the point of application of the resultant force exerted by the load on the apparatus.

In the context of the specification, “gait analysis” refers to the study and evaluation of an individual's walking or running patterns and biomechanics.

In the context of the specification, “tire analysis” refers to evaluation of a tire performance and condition, including factors like tread wear, tire tread, pressure, and overall integrity.

In the context of the specification, “balance assessment” refers to the evaluation and measurement of an individual's ability to maintain stability and equilibrium under various conditions, often involving tasks such as standing on one leg, maintaining a specific posture, or navigating uneven surfaces.

In the context of the specification, “sports biomechanics” refers to the application of mechanical principles and analysis techniques to study human movement in sports activities, optimizing athletic performance, preventing injuries, and refining training methodologies by examining factors like body mechanics, joint angles, forces, and motion patterns.

In the context of the specification, the term “processor” refers to one or more of a microprocessor, a microcontroller, a general-purpose processor, a Field Programmable Gate Array (FPGA), or an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to a non-volatile storage memory such as EPROM, EEPROM, flash memory, or the like.

In the context of the specification, the phrase “communication module” refers to a device enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

Embodiments of the present invention provide a apparatus (hereinafter also referred to as “the board”) designed to measure and analyze three-dimensional forces. The apparatus includes an upper plate and a lower plate. Further, the upper plate is surrounded by a wall that extends up to a certain distance from the periphery of the lower plate. The upper plate is provided with a plurality of first sensors. Further, the wall surrounding the upper plate includes multiple second sensors. The first and second sensors may be selected from a group consisting of strain gauges, piezoelectric sensors, capacitive sensors, tactile sensors, and a combination thereof. The first sensors and second sensors determine the various parameters such as shape, center of the distribution of ground reaction forces, and type of loads. Determining these parameters may facilitate the investigation of force measurement, center of pressure analysis, gait analysis, tire analysis, balance assessment, rehabilitation, and sports biomechanics. Further, both plates are separated by multiple horizontal and vertical load cells. The horizontal load cells are equipped with numerous pins, each of which is inserted into a hole provided on the upper plate. The insertion arrangement of the pins and the holes facilitates the determination and analysis of forces in the x-direction, y-direction, and z-direction.

Furthermore, multiple spherical balls are positioned between each of the vertical load cells and the upper plate to allow the displacement of the upper plate in the x-direction and y-direction. In addition, the spherical balls also contribute to determining the forces in the z-direction. Further, a control module is integrated into the apparatus to control the first sensors, second sensors, horizontal load cells, and vertical load cells. Furthermore, the apparatus is connected to an external communication device, enabling individuals to exchange input and output data.

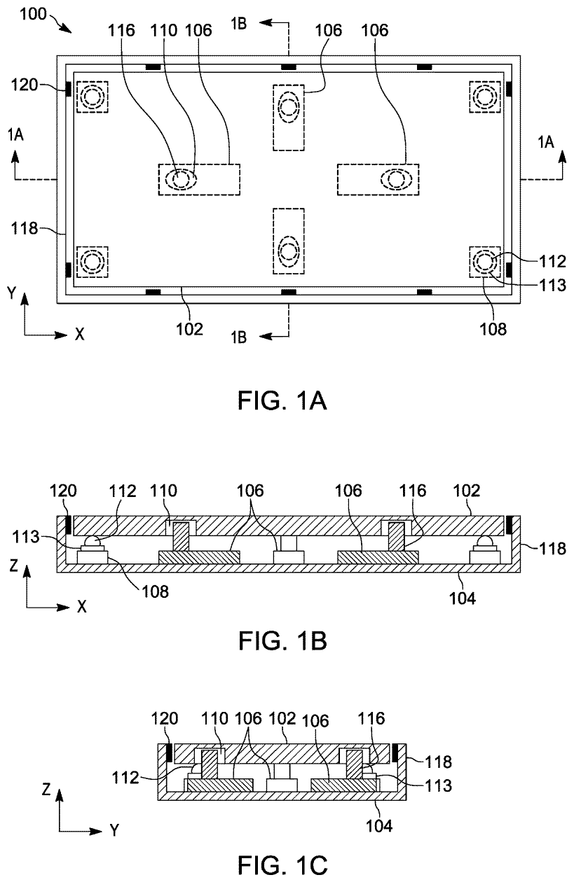

Several embodiments of the present invention will now be elucidated with the help of FIG. 1-12D.

FIG. 1A illustrates a top view of an apparatus 100 (hereinafter also referred to as “the apparatus 100”), in accordance with an embodiment of the present invention. FIG. 1B illustrates a cross-sectional view of the apparatus 100 along a section 1A-1A shown in FIG. 1A. FIG. 1C illustrates a cross-sectional view of the apparatus 100 along a section 1B-1B shown in FIG. 1A. The proposed apparatus 100 is designed for determining and analyzing the three-dimensional forces including magnitude and directions of the forces. The type of force, such as tensile force, compressive force, and shear force, can also be determined by the apparatus 100. In addition, the apparatus 100 can also measure the torque and the resultant forces applied by a load, which may include a static load and dynamic load. Moreover, the apparatus 100 can also be utilized to determine changes in load, center of gravity of the load, vibrations associated with the load, and the shape of the load. Additionally, the apparatus 100 also analyzes force losses that may occur during walking and running caused by plane forces not aligned with the direction of walking and running.

In several embodiments of the present invention, the apparatus 100 includes an upper plate 102 and a lower plate 104. The upper plate 102 is designed in a manner that the length and the width of the upper plate 102 are less than the length and the width of the lower plate 104. Both the upper plate 102 and the lower plate 104 are made of a material that is sufficiently strong enough to withstand the forces applied during measurement and analysis. The strength of the material may include some factors, such as yield strength, ultimate tensile strength, and fatigue strength. Further, the material of the upper plate 102 and the lower plate 104 also comprises properties such as durability, resistance to wear, anticorrosion, and other forms of degradation to enable the apparatus 100 to measure and analyze the forces independent of environmental conditions.

In several embodiments of the present invention, the apparatus 100 further includes a wall 118, which is attached to the periphery of the lower plate 104. The wall 118 extends from the periphery of the lower plate 104 towards the upper plate 102 up to a first distance. The first distance refers to the vertical distance from the lower plate 104 to the upper plate 102 level in the z-direction. The material of the wall 118 possesses properties similar to those of the upper plate 102 and the lower plate 104.

In alternate embodiments of the present invention, the length and the width of the upper plate 102 can be more than the length and the width of the lower plate 104. In that regard, the wall 118 extends from the periphery of the upper plate 102 towards the lower plate 104 up to a second distance. The second distance refers to the vertical distance from the upper plate 102 to the lower plate 104 level in the z-direction. In this alternate embodiment, the second sensors 120 will be surrounded by the lower plate 104. In this alternate embodiment, the methodology for determining and analyzing forces and shapes will remain consistent with the primary embodiment.

In several embodiments of the present invention, a plurality of horizontal load cells 106 and a plurality of vertical load cells 108 are positioned between the upper plate 102 and the lower plate 104. The orientation of the plurality of horizontal load cells 106 and the plurality of vertical load cells 108 in FIG. 1A, FIG. 1B, and FIG. 1C is in an x-direction, a y-direction, and a z-direction. However, the person skilled in the art can understand that the orientation of the horizontal load cells 106 is independent of the x-direction and the y-direction, i.e., the horizontal load cells 106 can be oriented at any angle greater than zero degrees from an x-axis, and less than 90 degrees from a y-axis.

In several embodiments of the present invention, the plurality of horizontal load cells 106 and the plurality of vertical load cells 108 can determine the forces in the x-direction, y-direction, and the z-direction. In several embodiments of the present invention, the plurality of horizontal load cells 106 and the plurality of vertical load cells 108 are a type of force sensors that include but are not limited to a plurality of first strain gauges, a Wheatstone bridge configuration, and a calibration unit. In that regard, the first strain gauges and similar sensors are arranged in the Wheatstone bridge configuration in a bridge circuit form. When a load is applied on the upper plate 102, the first strain gauges and similar sensors get deformed due to the force applied on the horizontal load cells 106 and the vertical load cells 108. Due to the deformation in the first strain gauges, a resistance is generated, which aids in measuring the magnitude and the direction of the force applied by the load. The measurement of the magnitude and the direction of the force is calibrated by the calibration unit to measure the forces accurately. Nevertheless, those skilled in the art can recognize that the force sensors, including the plurality of horizontal load cells 106 and the plurality of vertical load cells 108, may encompass alternative configurations, such as the quarter bridge configuration, among others, for determining the forces exerted by the load. Moreover, the methodology for determining forces may also vary according to the configuration employed for determining the forces.

In several embodiments of the present invention, a plurality of spherical balls 112 is placed between each of the vertical load cells 108 and the upper plate 102. The material of the plurality of spherical balls 112 includes homogenous and isotropic properties. Due to homogenous and isotropic properties, the spherical balls 112 exhibit uniform structure and the same mechanical behavior in all directions within the spherical balls 112. Due to the uniform structure and same mechanical behavior of the spherical balls 112, the upper plate 102 can securely move in the x-direction and the y-direction. In several embodiments of the present invention, when a dynamic load is applied on the upper plate 102, each of the spherical balls 112 rolls or moves freely. Moreover, each of the spherical balls 112 is equipped with a ring 113, which serves to restrict the movement of each of the spherical balls 112 under the dynamic load.

In several embodiments of the present invention, each of the horizontal load cells 106 provided with a plurality of pins 116. Each of the pins 116 is inserted into a correspondence hole from a plurality of holes 110 provided on the upper plate 102. The plurality of holes 110 is preferably elliptical in shape. However, a person skilled in the art can understand that the shape of the plurality of holes 110 can be different, such as circular or semi-circular. When a dynamic load is applied on the upper plate 102, the upper plate 102 moves in the x-direction and the y-direction, due to which the plurality of pins 116 comes in contact with the inner circumference of the holes 110. When the pins 116 collide with the inner circumference of the holes 110, the first strain gauges in the load cells get deformed, due to which resistance will be offered. The generated resistance is measured and calibrated by the calibration unit to measure the proportional force applied by the load.

In several embodiments of the present invention, in FIG. 1A, FIG. 1B, and FIG. 1C, the vertical load cells 108 are provided with the spherical balls 112, due to which the vertical force due to the weight of the load can be determined. In several embodiments of the present invention, a plurality of second sensors 120 is installed on the wall 118 around the upper plate 102 at a predetermined distance from the upper plate 102. The plurality of second sensors 120 may be selected from a group consisting of second strain gauges, first piezoelectric sensors, first capacitive sensors, first tactile sensors, and a combination thereof. The plurality of second sensors 120 is provided over the wall 118 to measure the forces in the x-direction and the y-direction accurately.

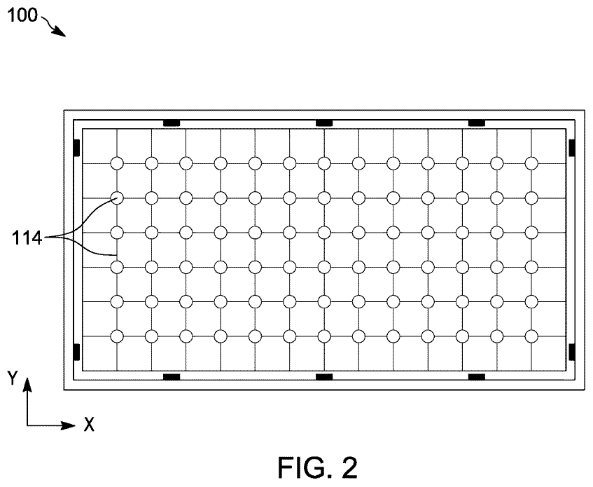

FIG. 2 illustrates a top view of the apparatus 100 depicting a plurality of first sensors 114, in accordance with an embodiment of the present invention. In several embodiments of the present invention, the plurality of first sensors 114 is provided in the upper plate 102. The plurality of first sensors 114 may be selected from a group consisting of third strain gauges, second piezoelectric sensors, second capacitive sensors, second tactile sensors, and a combination thereof. The plurality of first sensors 114 determines a first parameters, such as the shape of the load, the magnitude of the force due to static load, the magnitude of the force due to dynamic load, the direction of the force due to dynamic load, and the center of the load. The measurement of the first parameters by the plurality of first sensors 114 facilitates the determination of force measurement, center of pressure analysis, gait analysis, tire analysis, balance assessment, rehabilitation, and sports biomechanics.

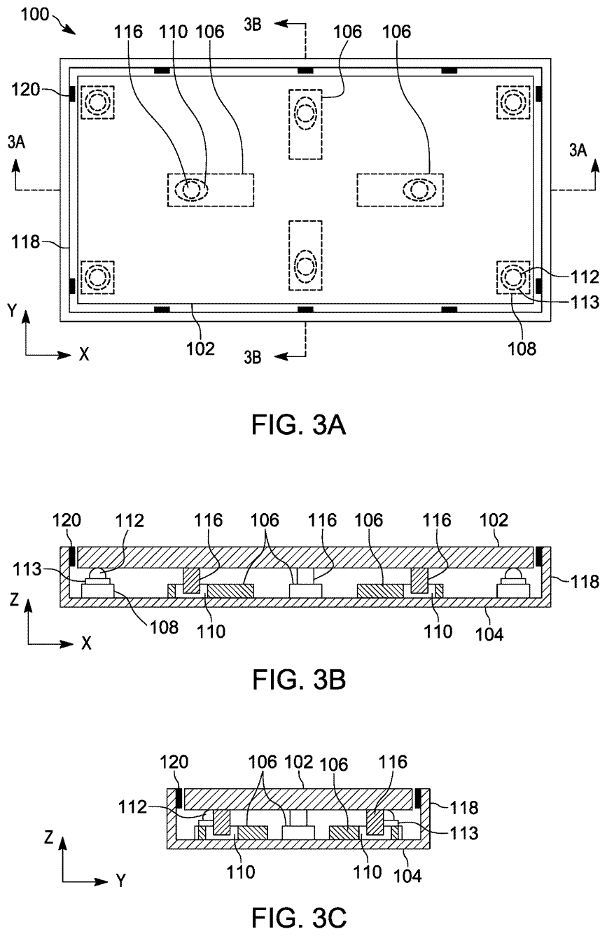

FIG. 3A illustrates an alternative top view of the apparatus 100 depicting the plurality of pins 116 fixed with an upper plate 102 of the apparatus 100, in accordance with another embodiment of the present invention. FIG. 3B illustrates a cross-sectional view of the apparatus 100 along a section 3A-3A shown in FIG. 3A. FIG. 3C illustrates a cross-sectional view of the apparatus 100 along a section 3B-3B shown in FIG. 3A. In an alternate embodiment of the present invention, the plurality of holes 110 is provided on each of the horizontal load cells, and the plurality of pins 116 is fixed on a lower side of the upper plate 102. The plurality of pins 116 is inserted into each of the correspondence holes 110 provided on each of the horizontal load cells. When a dynamic load is applied on the upper plate 102, the upper plate 102 moves in the x-direction and the y-direction, due to which the plurality of pins 116 fixed with the upper plate 102 comes in contact with the inner periphery of the holes 110. When the pins 116 collide with the inner periphery of the holes 110, the first strain gauges in the load cells get deformed, due to which resistance will be offered. The generated resistance is measured and calibrated by the calibration unit to measure the proportional force applied by the load.

In another embodiment of the present invention, the configuration provided in FIG. 3A, FIG. 3B, and FIG. 3C can be combined with the configuration provided in the FIG. 1A, FIG. 1B, and FIG. 1C. Some of the horizontal load cells 106 can be provided with the plurality of holes 110, whereas some of the horizontal load cells 106 can also be provided with the plurality of pins 116. In case, the horizontal load cells 106 are provided with the plurality of holes 110. In that regard, the upper plate 102 is provided with the plurality of pins 116. In case, the horizontal load cells 106 are provided with the plurality of pins 116. In that regard, the upper plate 102 is provided with the plurality of holes 110.

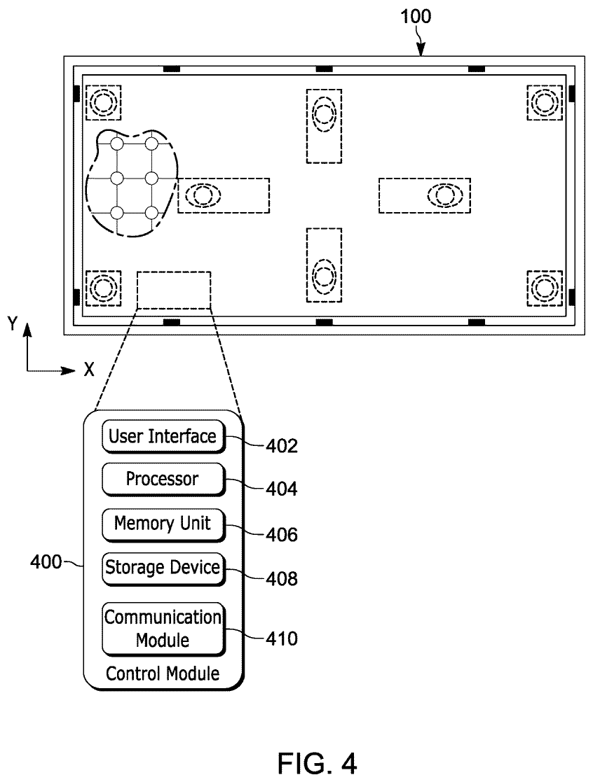

FIG. 4 illustrates a top view of the apparatus 100, depicting schematic of a control module 400 of the apparatus 100, in accordance with an embodiment of the present invention. In several embodiments of the invention, the control module 400 is integrated into the apparatus 100. The control module 400 controls the plurality of first sensors (shown in FIG. 2), the plurality of second sensors 120, the plurality of horizontal load cells 106, and the plurality of vertical load cells 108. The control module 400 may include a user interface 402, a processor 404, a memory unit 406, a storage device 408, and a communication module 410. In that regard, the user interface 402 allows an individual or an authorized person to provide input commands through the apparatus 100. The input commands may involve taring the apparatus 100 prior to commencing force measurement operations to prevent errors when reading measurement data.

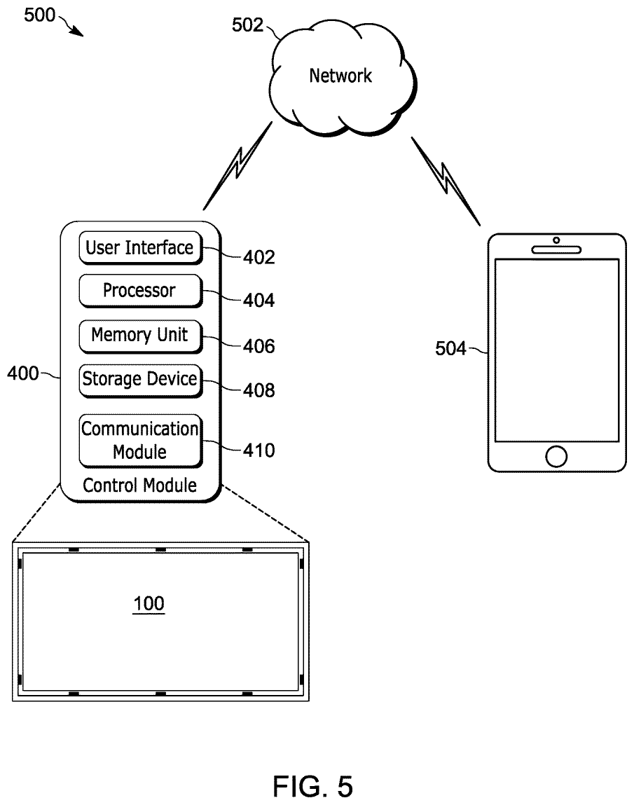

Further, the storage device 408 stores the data from the plurality of first sensors (shown in FIG. 2), the plurality of second sensors 120, the plurality of horizontal load cells 106, and the plurality of vertical load cells 108. The processor 404 then processes the stored data. Further, the memory unit 406 may be coded with machine-readable instructions that, when executed by the processor 404, may enable the processor 404 to receive, from the plurality of first sensors (shown in FIG. 2), the plurality of second sensors 120, the plurality of horizontal load cells 106, the plurality of vertical load cells 108, and an external communication device (shown in FIG. 5), through the communication module 410. Furthermore, the processor 404 is enabled to process the measured data in a synchronized manner to provide an accurate output. The measured data from the plurality of first sensors (shown in FIG. 2), the plurality of second sensors 120, the plurality of horizontal load cells 106, and the plurality of vertical load cells 108 will be sent to the processor 404, which then calculates the first parameters and provides the output results on the external communication device (shown in FIG. 5).

FIG. 5 is a block diagram showing communication between the control module 400 of the apparatus 100 and the external communication device 504, in accordance with an embodiment 500 of the present invention. The apparatus 100 is communicating with the external communication device 504 through a communication network 502. The communication network 502, in that regard, may be set up following protocols described in IEEE 802.x (Ethernet and Wi-Fi), HSDPA, HSPA, ZigBee, Bluetooth, Controller Area Network (CAN) and the like. In that regard, the apparatus 100 may communicate through wired and/or wireless means. Further, the external communication device 504 may be a mobile phone, a desktop, and a laptop.

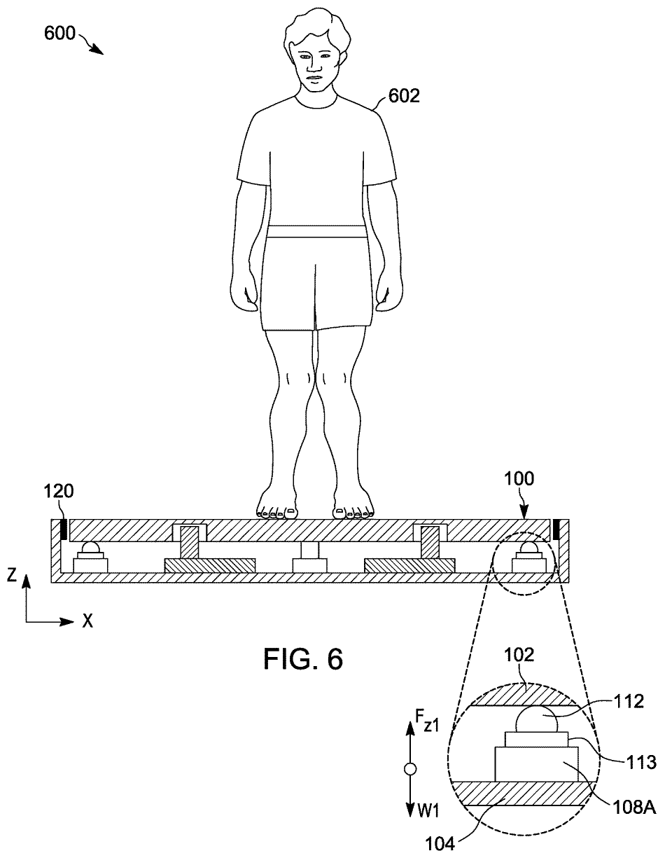

FIG. 6 illustrates the apparatus 100 in a state being used to determine and analyze the forces in static load conditions, in accordance with an embodiment 600 of the present invention. In this embodiment 600, a user 602 is shown standing on the apparatus 100. The shape of the feet of the user 602 is determined by the plurality of first sensors (shown in FIG. 2) as per the area covered by the user's 602 feet. As the user 602 is standing on the apparatus 100, the load exerted by the apparatus 100 will be static. Under this static load condition, due to the weight of the user 602, the upper plate 102 experiences downward forces in the z-direction. The same downward forces are experienced by the spherical balls 112 provided between the vertical load cells 108 and the upper plate 102. As the spherical balls 112 are positioned on the vertical load cells 108, the downward forces exerted by the plurality of vertical load cells 108 are the same as the forces experienced by the spherical balls 112. Further, the downward forces may be uniform and non-uniform depending on the area of contact of the user 602 with the apparatus 100.

Further, each of the vertical load cells 108 measures a reaction force generated in response to the corresponding downward force. For example, a vertical load cell 108A from the plurality of vertical load cells 108 experiences a downward force W₁. The corresponding reaction force generated in response to this downward force is represented by F_{z1}. The magnitude of the downward force W₁ is equal to the magnitude of the reaction force F_{z1}. Additionally, the direction of the downward force W₁ is opposite to the direction of the reaction force F_{z1}. This same principle applies to each of the other vertical load cells 108. Each of the other vertical load cells 108 experiences downward forces in a similar manner to that experienced by the vertical load cell 108A.

Subsequently, the processor (shown in FIG. 4) of the apparatus 100 will process the measured downward forces data based on the vertical load cells 108, the plurality of first sensor (shown in FIG. 2), and the plurality of second sensors. Upon processing the data, the processor (shown in FIG. 4) provides the output results, such as resultant forces, the direction of the forces, etc., on the external communication device (shown in FIG. 5) and the user interface (shown in FIG. 5). The output results are then utilized for analyzing gait analysis, tire analysis, balance assessment, rehabilitation, sports biomechanics, etc.

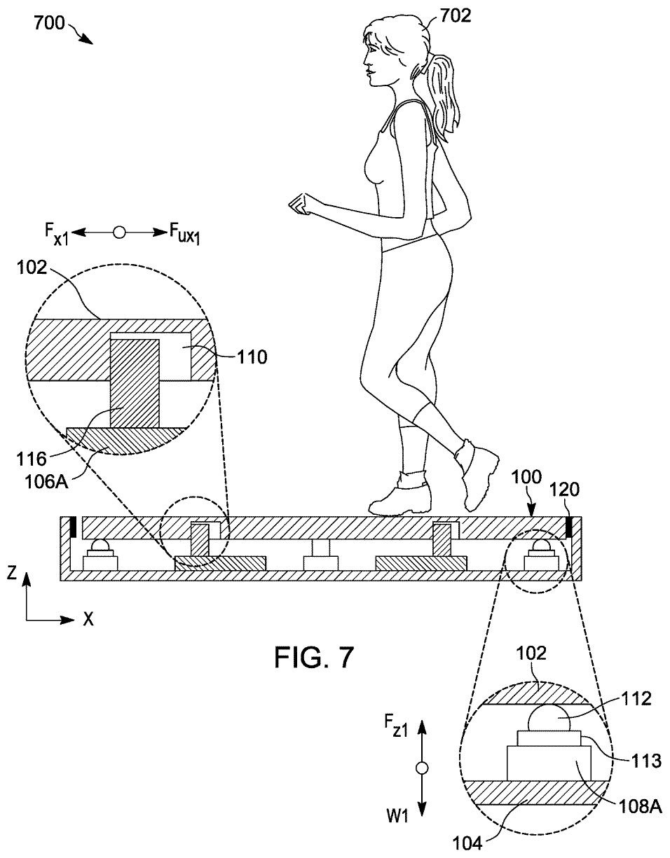

FIG. 7 illustrates the apparatus 100 in a state being used to determine and analyze the forces in dynamic load conditions, in accordance with an embodiment 700 of the present invention. In this embodiment 700, a user 702 is shown walking on the apparatus 100. The shape of the feet of the user 702 is determined by the plurality of first sensors (shown in FIG. 2) as per the area covered by the user's 702 feet. As the user 702 is walking on the apparatus 100, the load exerted by the apparatus 100 will be dynamic. In dynamic load conditions, the apparatus 100 experiences the force in the x-direction, the y-direction, and the z-direction.

When the dynamic load is applied on the apparatus 100, the upper plate 102 moves in the x-direction and the y-direction, due to which the upper plate 102 collides with the plurality of second sensors 120 provided over the wall 118. Also, the plurality of pins 116 fixed with the horizontal load cells 106 comes in contact with the inner periphery of the holes 110. When the pins 116 collide with the inner periphery of each of the holes 110, the horizontal load cells 106 measure the horizontal forces, which include the forces in the x-direction and the y-direction. In addition, when the dynamic load is applied on the apparatus 100, the upper plate 102 also experiences downward forces in the z-direction, which is measured by the plurality of vertical load cells 108.

Further, the forces in all directions may be uniform or non-uniform depending on the area of contact of the user 702 with the apparatus 100. The uniformity and non-uniformity of the forces also depend upon the walking pattern of the user 702 on the apparatus 100. The walking pattern depends upon the body mass of the user 702, the posture of the user, and other characteristics. Further, each of the vertical load cells 108 measures a vertical reaction force generated in response to the corresponding downward force. In that regard, for example, a vertical load cell 108A from the plurality of vertical load cells 108 experiences a downward force W₁. The corresponding reaction force generated in response to this downward force is represented by F_{z1}. The magnitude of the downward force W₁ is equal to the magnitude of the reaction force F_{z1}. Additionally, the direction of the downward force W₁ is opposite to the direction of the reaction force F_{z1}. This same principle applies to each of the other vertical load cells 108 for determining the downward forces or vertical forces. Further, each of the other vertical load cell 108 experiences downward forces in a similar manner to that experienced by the vertical load cell 108A.

Furthermore, each of the horizontal load cells 106 measures horizontal reaction forces generated in response to the correspondence horizontal forces. In that regard, for example, considering the horizontal force in the x-direction, a horizontal load cell 106A from the plurality of horizontal load cells 106 experiences a horizontal force Fᵤₓ₁ in the x-direction. The corresponding reaction force generated in response to this horizontal x-direction force is represented by Fₓ₁. The magnitude of the horizontal force Fᵤₓ₁ is equal to the magnitude of the reaction force Fₓ₁. Additionally, the direction of the horizontal force Fᵤₓ₁ is opposite to the direction of the reaction force Fₓ₁. Similarly, the horizontal force in the y-direction will also be analyzed in the same way as the horizontal force in the x-direction. This same principle applies to each of the other horizontal load cells 106 for determining the horizontal forces. Further, each of the other horizontal load cells 106 experiences downward forces in a similar manner to that experienced by the horizontal load cell 106A.

Subsequently, the processor (shown in FIG. 4) of the apparatus 100 will process the measured vertical forces and horizontal forces data based on the horizontal load cells 106, the vertical load cells 108, the plurality of first sensor (shown in FIG. 2), and the plurality of second sensors. Upon processing the data, the processor (shown in FIG. 4) provides the output results, such as resultant forces, the direction of the forces, etc., on the external communication device (shown in FIG. 5) and the user interface (shown in FIG. 5). The output results are then utilized for analyzing gait analysis, tire analysis, balance assessment, rehabilitation, sports biomechanics, etc.

In several embodiments of the present invention, a plurality of apparatus 100 can also be arranged in series and parallel to measure and analyze three-dimensional forces, determine parameters such as shape and distribution of ground reaction forces and vibrational changes, and facilitate various analyses, including gait analysis, tire analysis, balance assessment, and sports biomechanics. Additionally, the size of the apparatus 100 may differ based on the particular application, leading to variations in the number of vertical load cells and horizontal load cells.

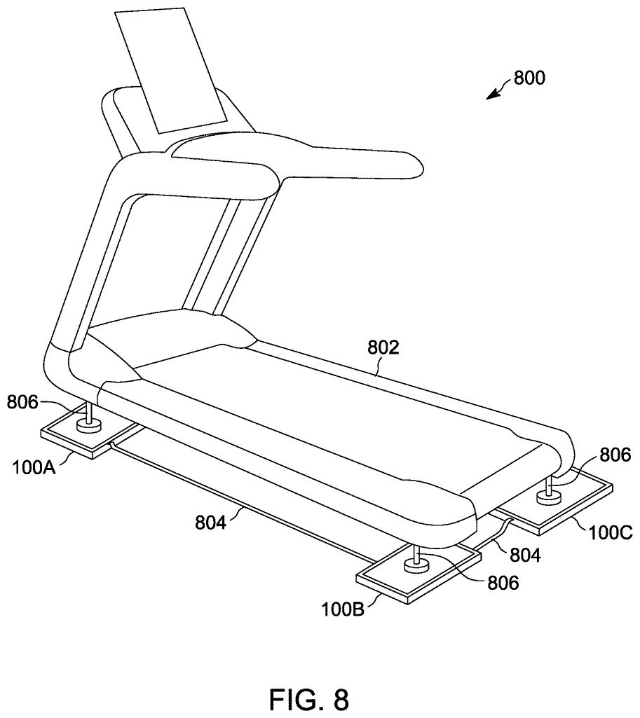

FIG. 8 illustrates an application of a plurality of apparatus 100A, 100B, and 100C in a treadmill 802, in accordance with an embodiment of the present invention. The treadmill comprises at least four legs 806, with three legs 806 from the at least four legs 806 shown in FIG. 8. Each of the legs 806 is placed over a respective apparatus 100A, 100B, 100C, and 100D (not shown). Further, each of the apparatus 100A, 100B, 100C, and 100D (not shown) are interconnected via a cable wire 804 for measuring the force, shape, and balance data in a synchronized manner. The cable wire 804 facilitates the synchronized data collection from all interconnected apparatus 100A, 100B, 100C, and 100D (not shown), enabling comprehensive analysis of the treadmill 802 performance and user interaction while walking or running on the treadmill 802. This setup 800 allows for real-time monitoring and assessment of the first parameters crucial for optimizing exercise routines and enhancing the user experience.

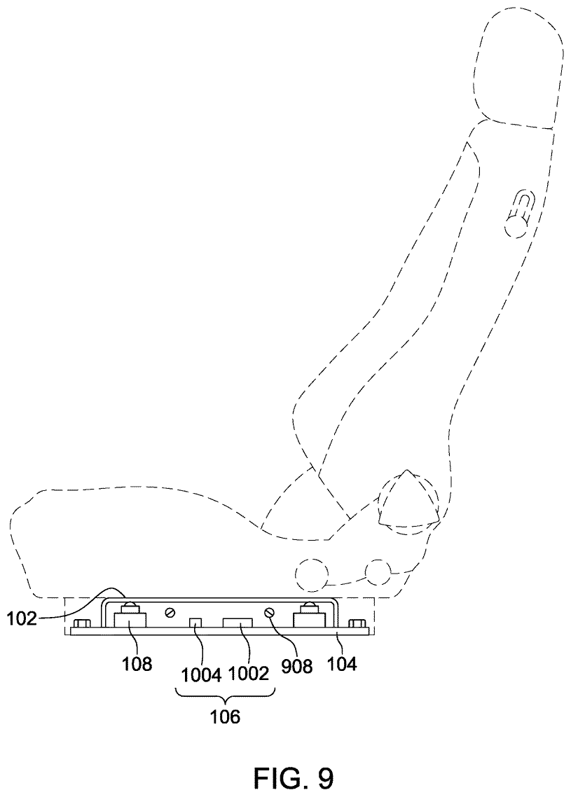

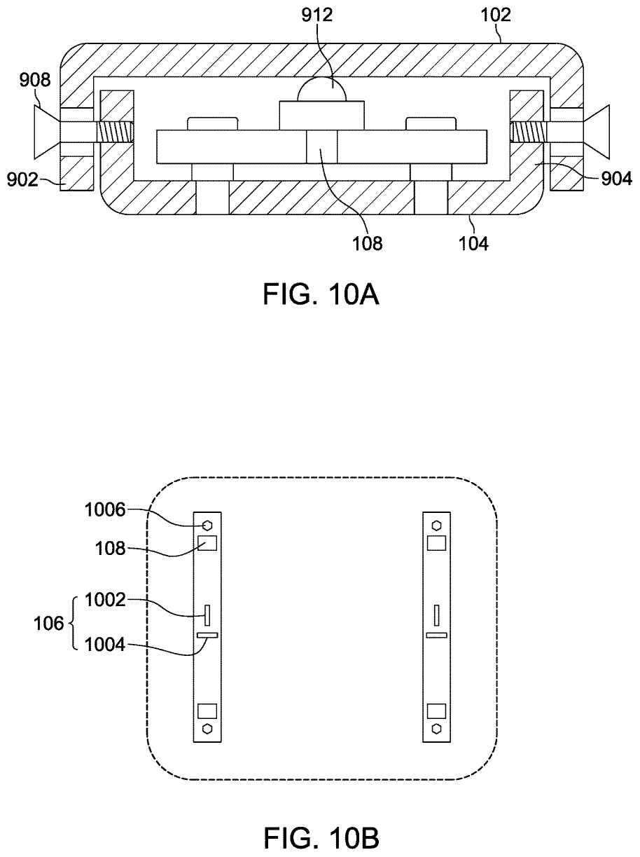

In another embodiment of the present invention, the apparatus can be used in a seat of a vehicle to measure and analyze load and weight characteristics of a passenger in the seat of the vehicle. Measuring weight characteristics of a passenger in the vehicle is essential for several reason, especially in context of vehicle safety and performance. FIG. 9, FIG. 10A and FIG. 10B shows a vertical cross-section of the apparatus fitted into the seat of a car for measuring load and weight characteristics of the passenger. The apparatus 100 is designed for determining and analyzing the three-dimensional forces including magnitude and directions of the forces acting on the seat of the vehicle. The type of force, such as tensile force, compressive force, and shear force, can also be determined by the apparatus 100. In addition, the apparatus 100 can also measure the torque and the resultant forces applied by the passenger. Moreover, the apparatus 100 can also be utilized to determine changes in load, center of gravity of the load, vibrations associated with the load, and the shape of the load.

The apparatus 100 comprises a lower plate 104 and an upper plate 102 placed underneath the seat rail. The length and width of the upper plate 102 are less than the length and width of the lower plate 104. Alternatively the length and width of the upper plate 102 are greater than the length and width of the lower plate 104. Both the upper plate 102 and the lower plate 104 are made of a material that is sufficiently strong enough to withstand the weight of the passenger applied during measurement and analysis. The strength of the material may include some factors, such as yield strength, ultimate tensile strength, and fatigue strength. Further, the material of the upper plate 102 and the lower plate 104 also comprises properties such as durability, resistance to wear, anticorrosion, and other forms of degradation to enable the apparatus 100 to measure and analyze the forces independent of environmental conditions.

The sides of the lower plate 104 are extended vertically upward to form the side walls 904 so that the lower plate 104 is U-shaped. Similarly, the sides of the upper plate 102 are extended vertically downward to from the side walls 902 so that the upper plate 102 is U-shaped. The upper plate 102 and the lower plate 104 are fitted in a configuration such that the side walls 902 of the U-shaped upper plate 102 or the lower plate 104 overlaps the side wall 904 of the corresponding upper plate 102 or lower plate 104. The side wall 902 of the upper plate 102 is at a distance 8 from the side wall 904 of the lower plate 102. Similarly, the upper plate 102 is at a distance 8 from the contact point of the side walls 904 of the lower plate 104.

In an embodiment, the lower plate 104 and the upper plate 102 can be extended vertically from all four sides to form an open-box shaped enclosure. The lower plate 104 is connected to the chassis of the vehicle by screw or other fixing mechanism. A spacer 906 is placed between the bolt which fixes the seat to the screw of the chassis to limit the screwing force on the upper plate 102 and to allow free movement of the upper plate 102.

The side walls 904 of the lower plate 104 and the side walls 902 of the upper plate 102 are movably fix with each other using one or more screw 908. The side walls 904 of the lower plate 104 is provided with threaded hole to fasten the screw 908. The side wall 902 of the upper plate 102 is provided with hole at corresponding position. The size of the hole in the side wall 902 of the upper plate 102 is more than the diameter of the screw 908 so as to allow the free movement of the upper plate 102. The one or more screw 908 keeps the upper plate 102 and the lower plate 104 together and prevent them from falling down.

The plurality of horizontal load cells 106 and a plurality of vertical load cells 108 are positioned between the upper plate 102 and the lower plate 104. The orientation of the plurality of horizontal load cells 106 and the plurality of vertical load cells 108 is shown in FIG. 1A, FIG. 1B, and FIG. 1C is in an x-direction, a y-direction, and a z-direction. The plurality of horizontal load cells 106 and the plurality of vertical load cells 108 can determine the forces in the x-direction, y-direction, and the z-direction. The plurality of horizontal load cells 106 and the plurality of vertical load cells 108 are a type of force sensors that include but are not limited to a plurality of first strain gauges, a Wheatstone bridge configuration, and a calibration unit. In that regard, the first strain gauges and similar sensors are arranged in the Wheatstone bridge configuration in a bridge circuit form. When the seat of the vehicle is occupied by the passenger, a load is applied on the upper plate 102, the first strain gauges and similar sensors get deformed due to the force applied on the horizontal load cells 106 and the vertical load cells 108. Due to the deformation in the first strain gauges, a resistance is generated, which aids in measuring the magnitude and the direction of the force applied by the load. The measurement of the magnitude and the direction of the force is calibrated by the calibration unit to measure the forces accurately. The upper plate 102 is suspended on the sensor head. A bearing 912 is provided on the sensor head. The diameter of the bearing is less than the diameter of the sensor head.

In an embodiment of the present invention, the horizontal load cells 106 and the vertical load cells comprises 108 a film based sensor or a foil based sensor, preferably a film based sensor. The film based sensor comprises a thick metal plate on which a printed board is glued by a structural glue. The sensor made by thick or thin film technology is applied to the printed board by printing a resistive paste on a ceramic layer. Resistive paste forms contacts which are connected by soldering to the corresponding contacts of the printed board. Upon application of force to the sensor, the ceramic deforms and causes the resistance to extend and to change its value. The variation of the resistance is linearly proportional to the force applied to the single sensor. The sensors formed by one resistance are arranged on the matrix of columns and rows and are connected to the printed board, which is then amplified to determine the movement. FIG. 10B shows a top view of the apparatus provided in a seat of a vehicle for measuring load characteristics in accordance with an embodiment of the present invention. A plurality of tracks or cantilever beams are provided underneath the seat of the vehicle. Each of the plurality of tracks comprises one or more horizontal load cells 106 and vertical load cells 108. The track are supported under the seat using a fastening mechanism, such as nuts and bolts or fasteners. FIG. 10B shows a pair of tracks under the seat. Each tracks comprises vertical load cells 108 at the two ends of the track to determine the load in z-axis, and a horizontal load cell 106 to detect the motion in x-axis and y-axis, such that the horizontal load cell 106 with sensor 1002 track the movement in x-axis and the horizontal load cell with sensor 1004 track the movement in y-axis. Each of the plurality of tracks is fastened to the chassis using one or more screw 1006.

Each of the horizontal load cells 106 provided with a plurality of pins 116. Each of the pins 116 is inserted into a correspondence hole from a plurality of holes 110 provided on the upper plate 102. When a dynamic load is applied on the upper plate 102, the upper plate 102 moves in the x-direction and the y-direction, due to which the plurality of pins 116 comes in contact with the inner circumference of the holes 110. When the pins 116 collide with the inner circumference of the holes 110, the first strain gauges in the load cells get deformed, due to which resistance will be offered. The generated resistance is measured and calibrated by the calibration unit to measure the proportional force applied by the load.

The vertical load cells 108 are provided with the spherical balls 112, due to which the vertical force due to the weight of the load can be determined. The plurality of second sensors 120 is installed on the U-shaped wall of the apparatus. The plurality of second sensors 120 may be selected from a group consisting of second strain gauges, first piezoelectric sensors, first capacitive sensors, first tactile sensors, and a combination thereof. The plurality of second sensors 120 is provided over the side wall to measure the forces in the x-direction and the y-direction accurately.

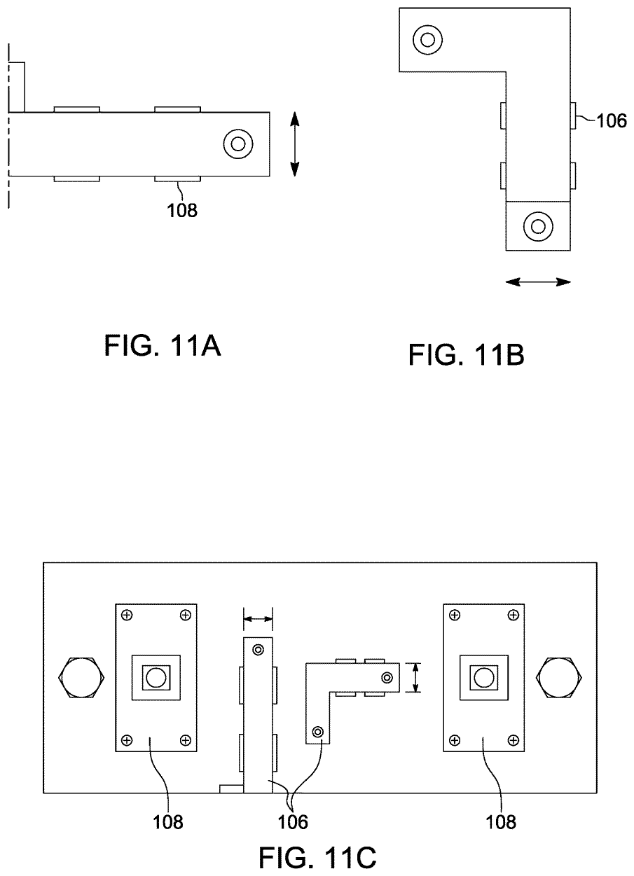

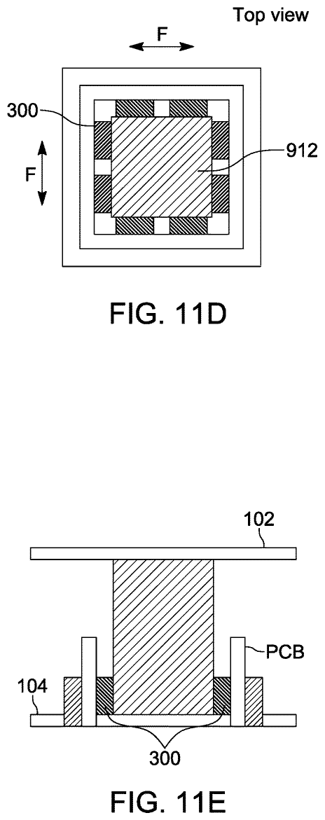

FIG. 11A shows a configuration of a cantilever loaded with the vertical load cells 108 to monitor the movement of the upper plate in z-axis. FIG. 11B shows a configuration loaded with the horizontal load cells 106 to monitor the movement of the upper plate in x-axis and y-axis. The cantilever loaded with the horizontal load cells and the vertical load cells are positioned between the upper plate and the lower plate to measure the force in x-axis, y-axis and z-axis.

FIG. 11D shows the top view of the apparatus with the film based sensor 300 and FIG. 11E shows the side view of the apparatus with the film based sensor 300 to measure the movement in x-axis, y-axis and z-axis.

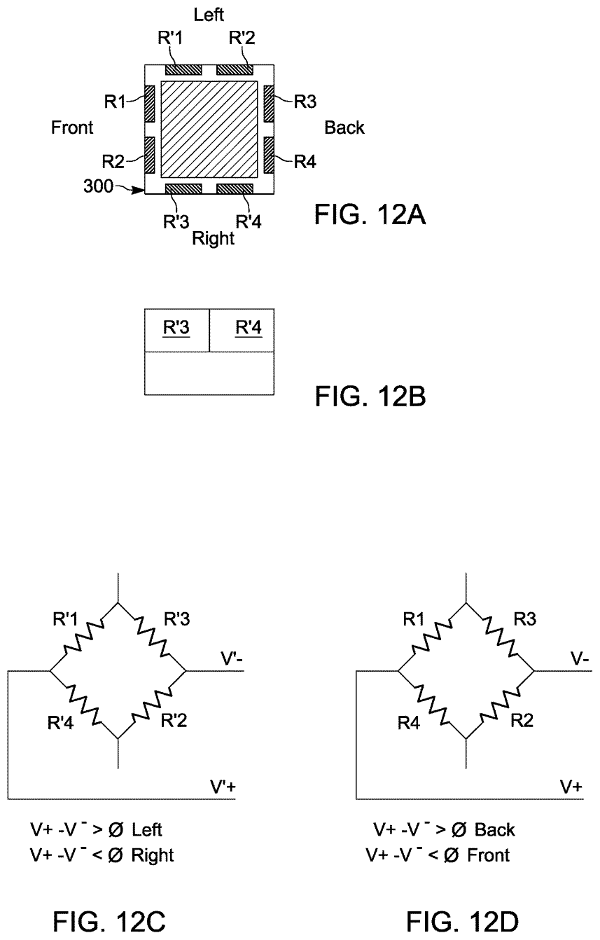

FIG. 12A shows a top view and FIG. 12B shows a side view of the film based sensor 300. FIG. 12C shows the change in resistance value when the upper plate is moved in left and right direction and FIG. 12D shows the change in resistance value when the upper plate is moved in front and back direction. The sensor comprises resistor R1 and R2 at front, resistor R3 and R4 at back, resistor R′1 and R′2 at left and resistor R′3 and R′4 at right. The right side view shows R′3 and R′4. The circuitry for measurement of resistance variation for left-right movement is shown in FIG. 12C. The sensor 300 act as a tactile sensor. The upper plate 102 is free to push on the adjacent R′1 and R′2 or on the adjacent R′3 and R′4. Pushing on R′1 and R′2 will increase V′+-V′−, which means the upper plate is going towards left. Pushing on R′3 and R′4 will decrease V′+-V′−, which means it is going towards right side. Similarly, the circuitry for measurement of resistance variation for front-back movement is shown in FIG. 12D. The upper plate 102 is free to push on the adjacent R1 and R2 or on the adjacent R3 and R4. Pushing on R1 and R2 will increase V+-V−, which means the upper plate is going towards back. Pushing on R3 and R4 will decrease V+-V−, which means it is going towards front side.

The data from the plurality of horizontal load cells, the plurality of vertical load cells, the plurality of first sensors and the plurality of second sensors can be transmitted to a control module of the vehicle. The control module can also control and regulate the plurality of horizontal load cells, the plurality of vertical load cells, the plurality of first sensors and the plurality of second sensors. The control module can be in communication with a centralized vehicle control system to transmit the information of forces acting on the seat of the vehicle, which can then be used to determine the load and weight characteristics of the passenger. The centralized vehicle control system can control various aspects and functioning of the vehicle based on the determined weight characteristic of the passenger.

In an embodiment of the present invention, the centralized vehicle control system can control the deployment of airbags based on the determined weight of the passenger. Airbag can be dangerous if deployed at full force for lighter passengers (such as children). By measuring the weight, the centralized vehicle control system can adjust the deployment force or even deactivate if a child is detected, thereby improving passenger safety.

The centralized vehicle control system can also use the data on weight characteristics of the passenger for regulating seatbelt pre-tensioner activation. Seatbelt pre-tensioner tighten the seatbelt during a crash to reduce forward movement. The centralized control system activate and adjust the tension according to the weight characteristics of the passenger.

Another application is the passenger detection and warning system. If a passenger is detected but the seatbelt is nor fastened, the centralized vehicle control system can trigger alert. Further, the data on weight characteristic of the passenger can be used in dynamic weight distribution. By determining the weight of the passenger, the weight distribution in the vehicle can be balanced, which improves the vehicle stability, fuel efficiency and driving dynamics. Further, in case of crash, knowing the passenger's weight helps in analyzing crash data for post-accident investigation and future vehicle design improvement. In addition, for vehicles with adaptive suspension system, the weight of the occupants can affect how the vehicle adjusts the stiffness of the suspension, improving ride control and performance.

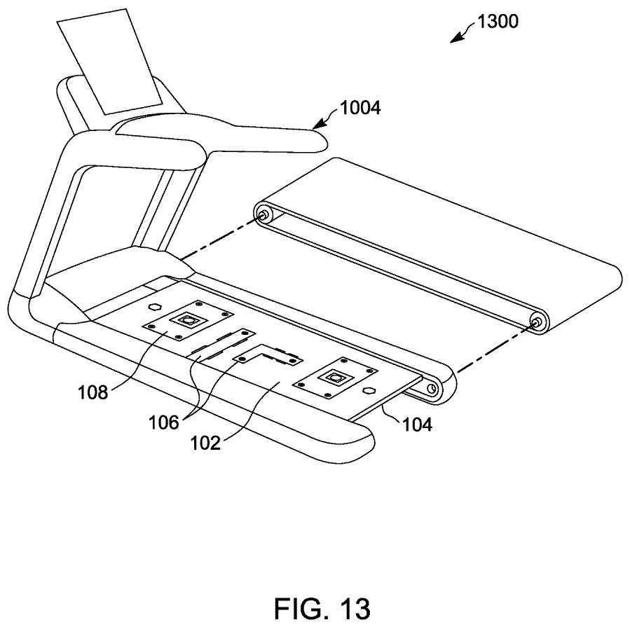

In an embodiment of the present invention, the apparatus with the plurality of horizontal load cells 106, the plurality of vertical load cells 108, the plurality of first sensor 114, and the plurality of second sensors 120 are used to determine the load characteristics of the load applied over a surface. In an embodiment, the load cells and the sensors are foil based sensor that makes the size of apparatus compact and thin. The apparatus is used to measure the three dimensional force characteristics in sports and rehabilitation center. FIG. 13 shows a treadmill 1300 with the apparatus fitted on a deck of the treadmill 1300, such that a person load characteristics can be monitored and determined while exercising and a feedback is generated based on the determined load characteristics. As shown in FIG. 13, the apparatus being thin in size is fitted over a deck of the treadmill. The belt of the treadmill 1300 is placed over the apparatus. The apparatus comprises a pair of vertical load cells 108 at the two ends of the deck, a plurality of horizontal load cells 106 are placed between the pair of vertical load cells 108. When a person runs on the belt of the treadmill 1300, the apparatus determines the load characteristics of the person over the belt.

The invention, as described above, offers several advantages. For instance, the apparatus is very simple in design and construction. Further, the apparatus uses commonly available materials. The simplicity in design and construction, and the use of commonly available materials allow the apparatus to be mass-produced with minimal capital expenditure, and to be made available in the market at significantly lower prices. Also, the apparatus can be reused several times and is, therefore, cost-effective for the end user and minimizes waste generation.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. An apparatus for measurement and analysis of load, the apparatus comprising:
an upper plate and a lower plate;
a plurality of horizontal load cells and a plurality of vertical load cells positioned on the lower plate to measure forces in an x-axis, a y-axis, and a z-axis;
a plurality of holes provided on the upper plate; and
wherein a plurality of pins are provided to connect with each of said horizontal load cells, with each of the plurality of pins is in contact with each of the plurality of holes provided on the upper plate.

2. The apparatus of claim 1 further comprising a wall that extends towards the upper plate from periphery of the lower plate up to a first distance, wherein the upper plate maintains a predetermined distance from the wall.

3. The apparatus of claim 2 further comprising a plurality of first sensor installed on the upper plate to determine a first parameter.

4. The apparatus of claim 3 further comprising a plurality of second sensors installed on the wall located around the upper plate to determine a second parameter.

5. The apparatus of claim 4 wherein the first parameter and the second parameter include but are not limited to a shape of load, a center of load, a magnitude, and a direction of load.

6. The apparatus of claim 4, wherein the plurality of first sensor and the plurality of second sensors is selected from a group consisting of a strain gauge, a piezoelectric sensor, a capacitive sensor, a tactile sensor or a combination thereof.

7. The apparatus of claim 5 further comprising a control module integrated into the apparatus to control the plurality of first sensor, the plurality of second sensors, the plurality of horizontal load cells, and the plurality of vertical load cells.

8. The apparatus of claim 1 wherein a plurality of spherical balls are placed between each of the plurality of vertical load cells and the upper plate.

9. The apparatus of claim 6, wherein the plurality of horizontal load cells and the plurality of vertical load cells are film based sensor.

10. The apparatus of claim 1, wherein the plurality of holes are elliptical in shape to allow movement of the plurality of pins in the x-axis and the y-axis.

11. An apparatus for measuring load information on a seat of a vehicle, the apparatus comprising:
a lower plate having a pair of side walls extended vertically upward;
an upper plate having a pair of side walls extended vertically downward;
wherein the pair of side walls of the upper plate covers the pair of side walls of the lower plate; and
a plurality of horizontal load cells and a plurality of vertical load cells positioned on the lower plate to measure forces in an x-axis, a y-axis, and a z-axis.

12. The apparatus of claim 11 further comprising a plurality of first sensor installed on the upper plate to determine a first parameter and a plurality of second sensors on the pair of side wall of the lower plate to determine a second parameter.

13. The apparatus of claim 12, wherein the plurality of horizontal load cells and the plurality of vertical load cells are film based sensor.

14. The apparatus of claim 12 further comprising a control module integrated into the apparatus to control the plurality of first sensors, the plurality of second sensors, the plurality of horizontal load cells, and the plurality of vertical load cells.

15. The apparatus of claim 14, wherein the control module is linked to a centralized vehicle control system to transmit load information.

16. The apparatus of claim 11 wherein the lower plate is fixed with a seat screw to allow the upper plate free to apply pressure on the plurality of horizontal load cells and the plurality of vertical load cells.

17. The apparatus of claim 11, wherein the pair of side walls of the lower plate extends vertically upward to form a U-shaped enclosure, and the pair of side walls of the upper plate extends vertically downward to form a U-shaped enclosure.

18. The apparatus of claim 11, wherein two opposite pair of side walls of the lower plate extends vertically upward to form an open box-shaped enclosure, and the pair of side walls of the upper plate extends vertically downward to form an open box-shaped enclosure.

19. An apparatus for measurement and analysis of load, the apparatus comprising:
an upper plate and a lower plate;
a plurality of horizontal load cells and a plurality of vertical load cells positioned on the lower plate to measure the forces in an x-direction, a y-direction, and a z-direction;
a plurality of holes provided on the upper plate; and
a plurality of spherical balls placed between each of the vertical load cells and the upper plate,
wherein a plurality of first sensors is installed on the upper plate to determine a first parameter, and
wherein a plurality of pins is fixed on each of the plurality of horizontal load cells, with each of the plurality of pins inserted into each of the plurality of holes provided on the upper plate.

20. The apparatus of claim 19, further comprising a wall that extends towards the upper plate from periphery of the lower plate up to a first distance, wherein the upper plate maintains a predetermined distance from the wall and a plurality of second sensors installed on the wall located around the upper plate.
